(19) United States
(12) Patent Application Publication
(10) Pub. No.: US 2016/0162919 A1
(43) Pub. Date: Jun. 9, 2016

(54) Lottery Communication System and Method

(71) Applicant: IGT Global Solutions Corporation, Providence, RI (US)

(72) Inventors: Bernadette Duponchel, Lincoln, RI (US); Paul Fazzano, Providence, RI (US); Alexander Healy, Glocester, RI (US); Connie Laverty-O'Connor, Tiverton, RI (US); Ira Lough, North Smithfield, RI (US); James Mycroft, Canterbury, CT (US); Susan Strouse, Westerly, RI (US)

(21) Appl. No.: 14/958,095

(22) Filed: Dec. 3, 2015

Related U.S. Application Data
(60) Provisional application No. 62/086,800, filed on Dec. 3, 2014.

(51) Int. Cl. G06Q 30/02; G06Q 40/00

(52) U.S. Cl. CPC G06Q 30/0205; G06Q 40/12

(57) ABSTRACT

A lottery communication system and method employs multiple device types communicating across a plurality of networks. According to various embodiments, the system and method utilizes a plurality of data collection terminals wherein retail sales data may be collected. Such information may then be communicated to a central processing component along with terminal information data specific to each of the plurality of data collection terminals. This terminal information data and retail sales data is supplemented with additional retail information and/or consumer information. Algorithmic processes facilitate analysis and normalization of the data to yield market insights, patterns, and trends across geographic boundaries, store types, and other parameters.

### RELATED APPLICATIONS

This application claims priority under 35 U.S.C. §119 to U.S. Provisional Application No. 62/086,800, titled System, Method and Device for Managing Electronic Lottery Data, filed 3 Dec. 2014, the entirety of which is incorporated herein by reference.

### FIELD OF THE INVENTION

The present invention relates to a lottery communication system, terminal devices and communication networks for facilitating such communications, and central processing systems for related information processing and analysis, including user interfaces.

### BACKGROUND AND SUMMARY OF INVENTIVE ASPECTS

Lottery operators (e.g., government lotteries) have traditionally used external lottery processing systems to operate lottery games and process lottery-related transactions. Lottery retailers work with lottery operators to distribute tickets and collect payments, and lottery retailers often earn payments from lottery operators based on selling winning tickets as well as overall sales. To date, lottery operators have lacked the ability to effectively share lottery transaction data across jurisdictions, and therefore take advantage of sophisticated information tools to help with sales growth and other business goals. Today, lottery operators, government lotteries, and retailers are currently demanding more retail insight to support sales and recruitment of new retailers.

Currently, there are no known systems allowing lottery customers/operators to electronically request searches or directly search through lottery transaction data for cross-jurisdiction chain stores and trade type performance business intelligence, for example. Missing components include, among other things, effective communication systems that would enable the communication of lottery transaction data across multiple jurisdictions to a central processing location. Also missing is the ability to augment such transaction data with non-lottery information such as, for example, area demographic information, geographic specific data, urbanicity information, etc., with lottery transaction data to facilitate the prediction of purchasing patterns and other desirable information. There further do not appear to be any currently operating algorithms or other special programming designed to automatically conduct forecasts or predictions (for example, forecasting potential outcomes based on consumer, retail chain and trade type trends in one jurisdiction based on past results in another jurisdiction), or to electronically evaluate potential opportunities for lottery operators.

In various aspects, the present invention incorporates a communication system with a proprietary database and user interface to provide retailer-level lottery transaction information across multiple retailers, retail formats and state lotteries. The communication system, data collection terminals, and analytical applications according to embodiments of the present invention provide valuable feedback on each state lottery's product sales and distribution, including retailer type statistics, specific retailer statistics, revenue, geographic metrics (e.g., median household income, retailers per capita) and opportunities, among other things. Embodiments of the system of the present invention can include data from third parties, such as lists of retailers, trade types, square footage, staffing, lanes and credit ratings, for example. Embodiments of the system of the present invention can further accept state lottery queries via pre-set filters for in depth analysis that may facilitate increased sales and optimization of lottery sales performance among retail chains and trade types. Among other things, embodiments of the present invention assist in developing a syndicated sales data repository for the lottery industry.

In various aspects, the present invention also provides a framework for advanced lottery transaction information governance. Leading technology research and advisory firms define “information governance” as the specification of decision rights and an accountability framework to ensure appropriate behavior in the valuation, creation, storage, use, archiving and deletion of information. It includes the processes, roles and policies, standards and metrics that ensure the effective and efficient use of information in enabling an organization to achieve its goals. Currently, there are no venues that aggregate retail transaction level lottery performance using a multi-jurisdictional communication network that includes lottery data collection terminals operated by retailers and/or lottery consumers. Embodiments of the present invention provide such a communications network along with a platform for information governance, normalizing definitions and characteristics of retail trade types, financial settlement terms, and games description among others. Normalization and data governance facilitate the rapid search and analysis of relevant transactional information instrumental in assisting lottery operators in effectively growing their business. While the present invention can be employed by lottery operators (e.g., government lotteries), it can also be used by lottery gaming sales managers, and gaming developers to communicate, plan and report performance with retailers, retail chains and other participants in the lottery environment.

It will be appreciated that aspects of the present invention provide network communication systems that facilitate strategic performance insights and best practice solutions across retail types, chains, and jurisdictions, and further provide direction for retail expansion efforts, with trade type and chain performance across multiple jurisdictions, for example. Aspects of the present invention further provide increased speed in analysis, accommodating centralized as well as jurisdictional requests. Aspects of the present invention further enable improved operations management efficiency, improved retailer negotiation leverage due to a normalized view of performance, and actionable best practice recommendations for relevant management personnel to facilitate immediate performance improvement.

### BRIEF DESCRIPTION OF THE DRAWINGS

FIGS. 1, 2 and 7 are schematic views of data inputs, manipulation, storage, management and presentation in accordance with aspects of the present invention.

FIGS. 3 through 6 are exemplary user interface displays in accordance with aspects of the present invention.

### DETAILED DESCRIPTION OF INVENTIVE ASPECTS

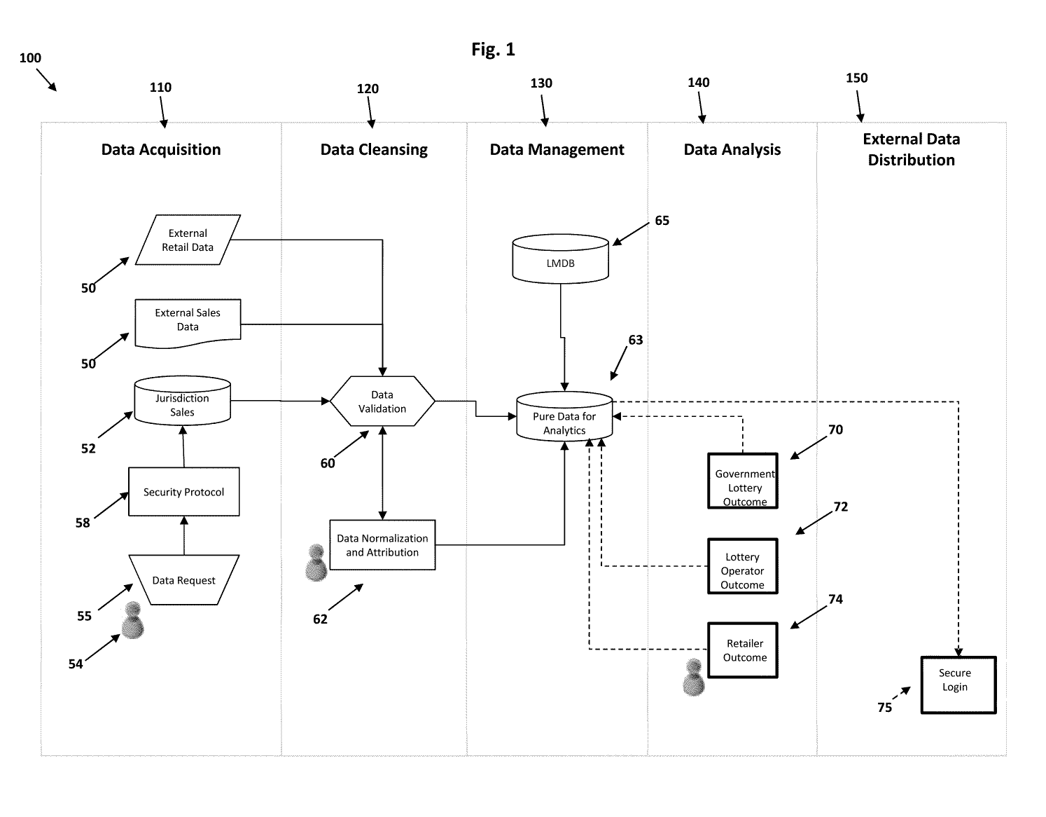

As shown and/or implied by FIG. 1, data may be acquired by system 100 at a data acquisition step 110. In some embodiments, data acquired for use in connection with aspects of the present invention at data acquisition step 110 can include lottery transaction data 50 from external sources such as retailers, as well as “internal” lottery data from lottery operators, such as (1) sales per day, per game, (2) sales per retailer, per day, per game, (3) sales forecast and budget data, (4) association data (e.g., multi-state lottery organization data), and (5) game sale data from lottery system providers (e.g., IGT Global Solutions Corporation of Providence, R.I.), for example. It will be appreciated that different games have different levels of success, and that many different games can be offered in individual jurisdictions at varying price points and using various game styles. Data related to the performance of one or more games in a family of games may also be acquired. The data can be collected according to automated systems configured to index and otherwise organize the acquired data, and/or the data can be entered manually into one or more computer-based systems operating programming according to the present invention. In one embodiment, the data is collected in .xlsx format (though other data collection formats may also be used (e.g., .xml, .csv, etc.)). FIG. 1 illustrates a user 54 making a data request as at 55 through a security protocol shown at 58.

For inputting/collecting the data associated with the lottery transactions across one or more jurisdictions, various hardware may be used, including non-player operated retailer terminals such as sales terminals, kiosks, or the like, and/or player operated retailer terminals such as user kiosks, user mobile devices/tablets, laptops, desktop computers, or any other device capable of identifying and collecting the necessary information and/or facilitating entry of the information by a user. Such hardware may, in some embodiments, be connected to a network (either via a hardwired connection or wireless connection) to facilitate the transfer of the collected information from individual collection points to remote storage locations (as discussed in more detail below). In preferred embodiments, a wide array of collection terminals may be employed to maximize the amount of data acquired and available for analysis.

Referring still to FIG. 1, at data cleansing step 120, a data cleansing operation can also be performed on the collected data. At data cleansing step 120, the collected data may be validated as at 60, supplemented, standardized, normalized, corrected, de-specified and otherwise treated in order to ensure accuracy and presentation in usable form, for example. In various embodiments, a data normalization and attribution operation 62 is performed using a central processing component as described elsewhere herein. Retailer business types can be segmented, game types and game names can be identified, and competitive and demographic data from various internal and external sources (e.g., census, commercial directories, etc.) can be evaluated and incorporated with the collected data for more in-depth insight, for example.

In some embodiments, trade type normalization may be employed at step 120 that uses non-lottery data. Examples of non-lottery data may include common retail characteristics that may facilitate a cross-jurisdictional analysis. For example, common characteristics (such as store size, store type, goods sold, etc.) may be used to more accurately compare data at one location to data from another location. Further, data augmentation information may be employed to supplement sales data collected at any given location with additional non-lottery data. For example, certain data may be employed to provide consumer information that can help provide retailer expansion analysis. In some embodiments, such data augmentation may include the analysis of data related to, among other things, particular store location urbanicity, trade area, and social demographic profile, population, household size, disposable income per household, whether consumers are locally employed vs. commuters, certain propensity to play indices (MPIs) among the relevant consumer cross-section, number of employees in a given store, tenure with the lottery, retail industry data related to expansion and consumer strategies and merger and acquisition data, for example. In various embodiments, the whole of the collected data is analyzed using a variety of analytical approaches that may include data mining, regression analysis and one or more custom algorithms. For example, one can mine the collected data to evaluate what type of characteristics could potentially affect sales. One can perform a regression analysis to understand how one of several elements impact one or more elements. Further, one can perform a regression analysis on multiple elements to uncover or confirm a specific “buying” pattern, which may be positive or negative. For instance, the sales of liquor in a supermarket may negatively impact the sales of instant lottery tickets in those locations and conversely improve the odds of selling draw-based lottery games. Further in the analytical process according to aspects of the invention, one can analyze the data to find where these combined elements are producing fewer sales than one may expect based on one or more benchmarks developed based on earlier regression analysis as exemplified above. Such determined locations may become candidates for same store sales improvement programs. Even further, one can use the same correlations to look for trade area, trade types and retailers that have similar characteristics as shown in the regression analysis. Information services can then be employed to understand these retailers' locations in those geographic areas, which may inform a lottery sales team to call on these retailers to expand lottery sales, for example.

Among other things, this analysis enables the confirmation and discovery of causality patterns between lottery sales and a variety of retailer(s) and/or trade type(s) strategic, locational, consumer and/or channel characteristics. Causality patterns enable “apple to apple” comparison and are leveraged to identify performance benchmarks used in sales optimization programs and strategies that may be translated in new/improved planograms, promotion strategies, retail incentives, etc. and lead to same store sales optimization. Similarly, causality patterns are used for Lottery expansion purposes, enabling the identification of “best match” potential lottery retailers, trade types and locations candidates for Lottery expansion and the most appropriate business model/delivery approaches thus reducing recruitment cycle time and retail churn.

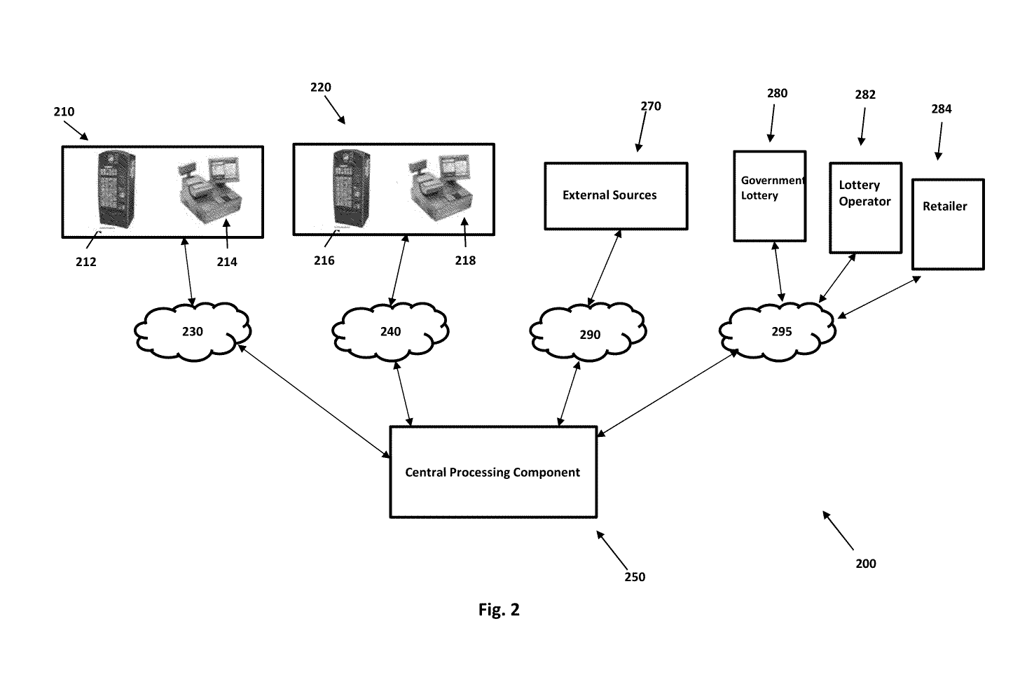

As further shown in FIG. 1, at data management step 130, the collected and cleansed data can be managed by a lottery information management system, as described above. The lottery management system can manage the data by efficiently storing it (e.g., in database 63), organizing it, and managing permissions in accordance with various aspects of the present invention. In various embodiments, the data can be stored using a landscape management database (LMDB 65) and/or resource planning software, optionally provided by an enterprise resource planning (ERP) software program, such as that provided by SAP AG of Germany. In various embodiments, lottery information management system and database 65 can be part of processing component 250 described below and with reference to FIG. 2.

At data analysis step 140 in FIG. 1, the lottery management system and/or processing component 250 may provide algorithms and other data manipulation programming to facilitate the various functions and purposes of the present invention. In some embodiments, the system may produce one or more user-specific outcomes, including for example a government lottery outcome 70, a lottery operator outcome 72, and/or a retailer outcome 74. In additional embodiments, the data can be linked to raw sales data in addition to other relevant lottery-related information such as jackpots, game attributes, etc. for correlation, causality and forecasting, for example. In this way, the present invention can provide a robust platform for queries (via various user interfaces for use by, for example, government lotteries, lottery operators, and/or retailers) and analytics, incorporating retailer, game level, and player level detail, as well as third party data, for optimized accuracy, relevance, forecasting and insight. Further, the present invention may provide user interfaces permitting analysis of the underlying stored data, such as through queries that can elicit customized responses depending upon, among other things, (1) the user, (2) programmed analytics algorithms in accordance with embodiments of the present invention, and (3) the underlying stored data. For example, a lottery operator in a specific jurisdiction may desire to know how a retail chain or trade type is performing relative to other stores/locations in one's own state or compared to similar chains or trade types in other states. The system according to embodiments of the present invention can accept such a request, process the request against stored data, and return text, charts, displays and other multi-media graphics in presenting an answer to the user's query. In various embodiments, the present invention can employ visualization software and data modeling/statistical software in processing requests and presenting results and analysis. Further still, such results and analysis may optionally be distributed externally (e.g., at external data distribution step 150) using secure logins (such as illustrated at 75) over various network interfaces known in the art.

Referring now to FIG. 2, an exemplary schematic diagram is presented illustrating an embodiment of the system 200 according to various aspects of the present disclosure. In some embodiments, one or more data terminals (e.g., self-service device 212 and/or retailer operated device 214) may be used to collect data in a first lottery jurisdiction 210 according to data collection step 110 discussed above. Similarly, one or more additional data terminals (e.g., self-service device 216 and/or retailer operated device 218) may be used to collect data in a second lottery jurisdiction 220. The data terminals can be player operated, such as a self-service kiosk, or can be non-player operated, such as a terminal behind a retail counter operated by a clerk, for example. The collected data from the first lottery jurisdiction 210 may then be transferred to a central processing component 250 via a first network 230, and the collected data from the second lottery jurisdiction 220 may then be transferred to the central processing component 250 via a second network 240. Certain terminal information data may also be transferred to the database via the first and second networks, such as, for example, geographic location, store size, number of terminals within the location, etc. Additional jurisdictions beyond 210 and 220 can be joined in communication with system 200. The terminal information data may also be supplemented with retail information or consumer information provided by, for example, external sources 270 as noted above. Such information may be transferred, for example, via a third network 290. Once the data is received, the central processing component 250 can store such information in one or more databases (not shown) and can employ algorithmic processes to analyze the data according to one or more parameters (e.g., the data analysis parameters discussed herein). Analyzed data may then be presented as consolidated data to one or more users via one or more user interfaces to, for example, government lotteries 280, lottery operators 282, and/or retailers 284. The user interfaces may present information as, for example, graphics, charts, text, and other presentation formats. Such information may be transferred to users from the central processing component 250 via, for example, a fourth network 295. Various types of networks can be employed in system 200, including private and public networks, wireless and wireline networks, for example. Sub-networks can also be employed, such as, for example, within a given lottery jurisdiction, retailer or other sub-component of system 200. For instance, a retailer may employ a local area network (LAN) permitting communications between various devices (e.g., player operated terminal 212 and non-player operated terminal 214), wherein the LAN is connected to a virtual private network (e.g., 230) for communication with component 250. Further, in various embodiments, the first, second, third, and fourth networks, or at least a sub-combination thereof, comprise the same network.

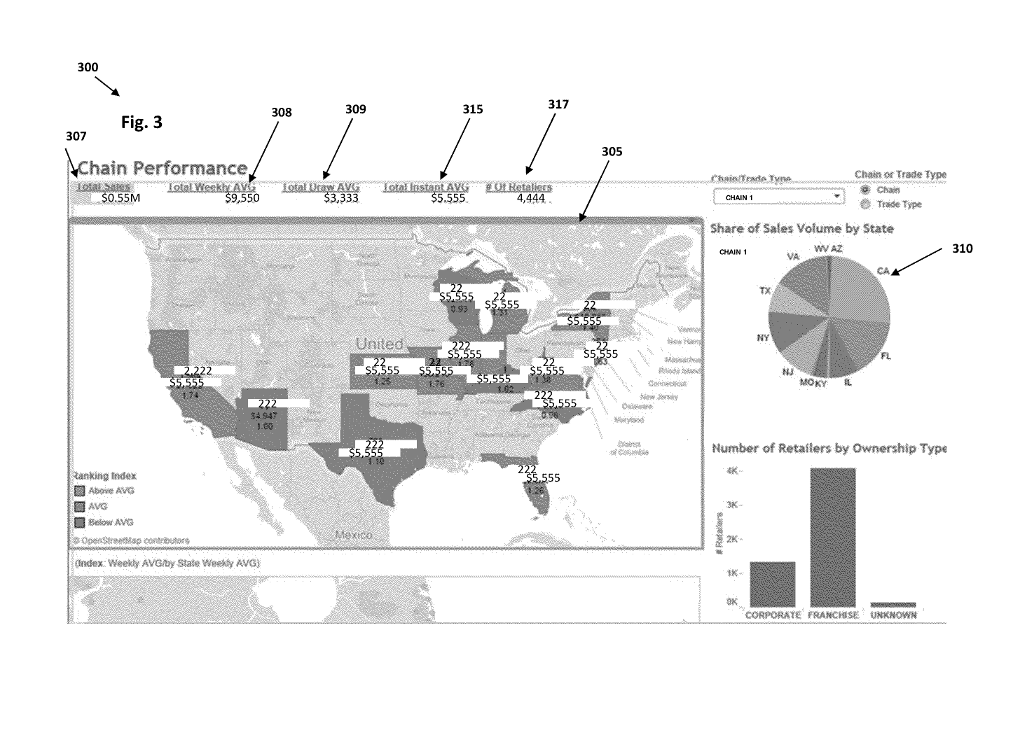

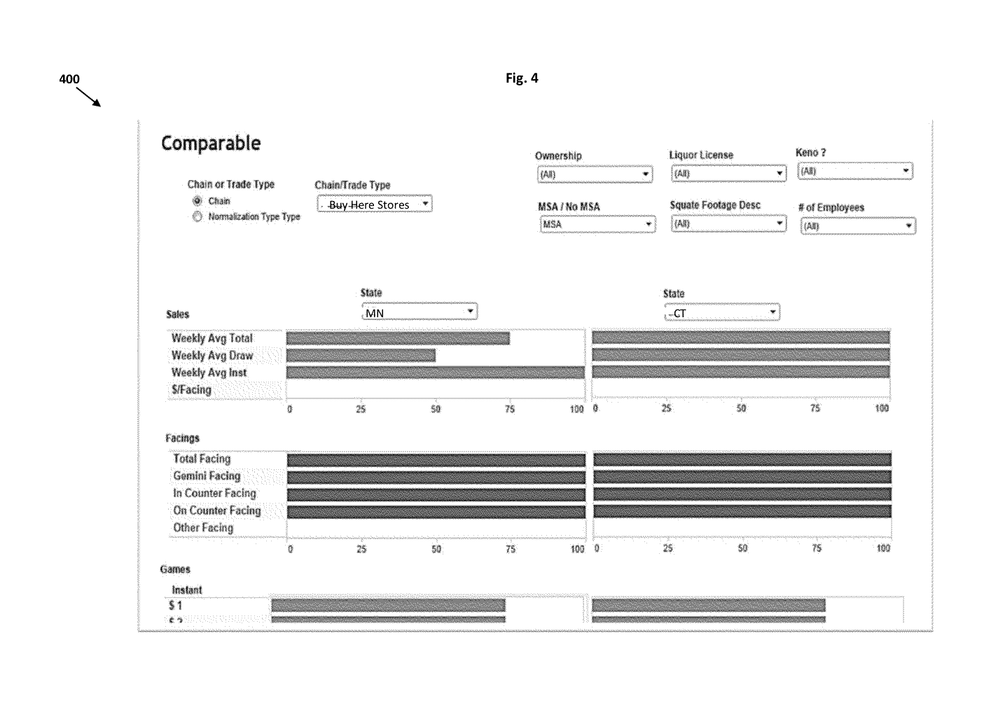

FIG. 3 shows an exemplary user interface 300 detailing retailer chains and trade type data across jurisdictions. As shown therein, the user interface according to embodiments of the present invention can reveal a map display 305 of states with corresponding map highlights associated with a retailer chain's performance For example, the interface in FIG. 3 shows total sales 307, average weekly sales 308, average sales of draw-based games 309, average sales of instant-based games 315 and a total number of retailers 317 for the given retailer chain. On the right side of the interface, a pie graph 310 showing shares of sales volume by state and number of retailers by ownership type is shown. It will be appreciated that game data, retailer data and location data can be aggregated, processed and presented for display based upon a wide variety of queries available to end users of the system of the present invention. It will further be appreciated that the retail and jurisdictional performance information can be combined with game data and player data to provide a true and complete view of lottery performance Other data can be provided on such a user interface of a retailer chain performance, including, for example, parent company details that can be drilled into to show specific subsidiary performance information. Such information can further be organized by trade type, such as by convenience store, fuel kiosk, drug store, truck stop, liquor store, tobacco shop, mass merchant, restaurant, large supermarket, gas station, financial services establishment, and others, for example. Additionally, compare and contrast analysis as shown in interface 400 of FIG. 4 is enabled by data normalization and external data augmentation to provide true “apples to apples” performance comparison at the quartile level based on similar operating characteristics such as trading area, square footage and lanes, for example. State lotteries data security and confidentiality is ensured and built into various embodiments of the system of the present invention. Also, the lottery operators can view national high level statistical information and can also drill down into detailed sales information within their own, and optionally only within their own, jurisdiction, for example.

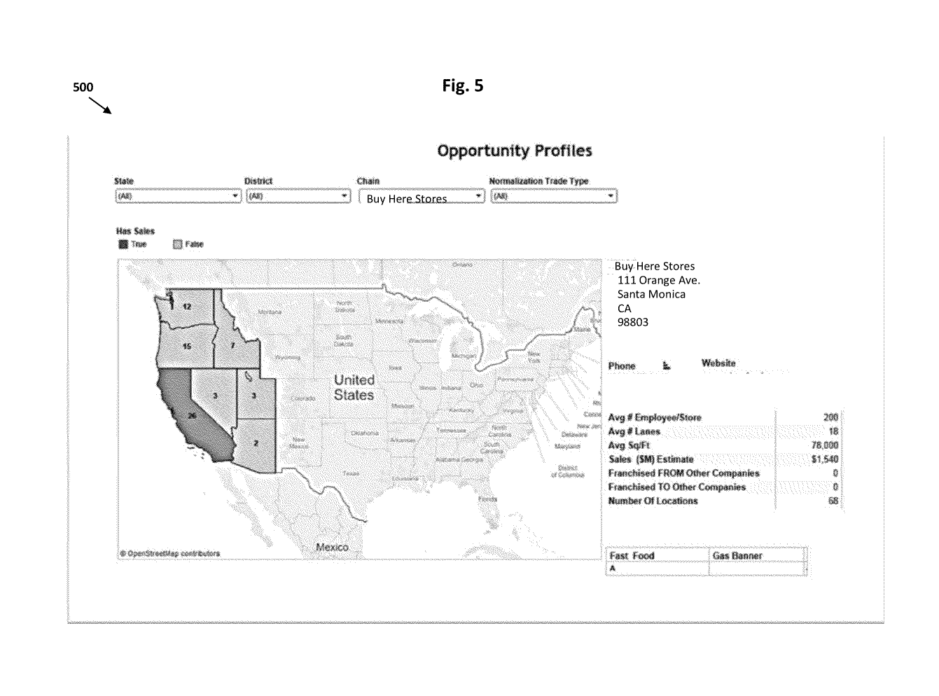

As shown in interface 500 of FIG. 5, by combining first and secondary market research with cross jurisdiction chains and trade type analysis, the application according to embodiments of the present invention provides a list of selected retailers and their characteristics profiled as potential lottery resellers. Profiles can include performance and marketing information needed to develop business value proposition for inclusion in a sales presentation by the jurisdiction(s) to targeted retailers and chain executives, for example. Similarly, this aspect of the present invention can also highlight retail chains who are lottery resellers in some but not all states for lottery sales expansion.

In some embodiments, a single view of retailer chain and trade type data across multiple jurisdictions may be presented. In such embodiments, sales may be normalized by trade type for a cross-jurisdictional comparison of, for example, total sales, average weekly sales by store, number of locations, and/or be indexed to state averages. Additionally, certain filters may be utilized, including for example whether the store is a corporate retail chain, a corporate chain vs. a franchise, or according to set relevant time periods desired by the user. Further still, additional store characteristics such as trading area, store square footage, number of checkout lanes, etc. may be utilized to further analyze and compare data.

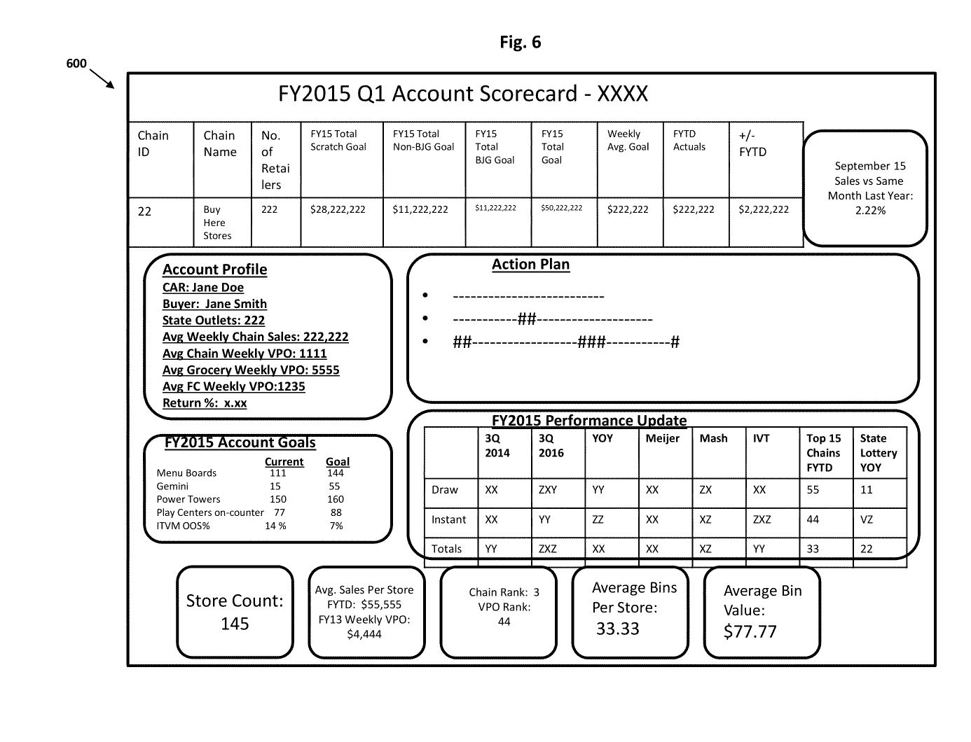

Using the data within the various embodiments of the system of the present invention and state lotteries' pre-approved key performance indicator (KPI) benchmarks, (such as store count, average sales per store, chain rank, average bins per store, and average bin value, for example), embodiments of the system can generate Aggregated Chain Performance Scorecards (e.g., see interface 600 of FIG. 6) that jurisdictions can present to retailers during their regular performance review and strategy planning sessions, for example. This approach provides a unified template to facilitate communication between jurisdictions and retail chains needed to create effective joint plans for lottery sales optimization. Additional interfaces beyond the scorecard in FIG. 6 can be provided to show different details depending upon the desires of the user or end data recipient. For example, weekly averages sales of a given product or aggregate products can be provided for multiple jurisdictions at the same time, including different displays broken down by whether the retail ownership is corporate or individual, or based on the given trade type (e.g., bar/lounge versus restaurant), for example.

Analysis from the various embodiments of the system of the present invention can be made available to state jurisdictions in a secure and confidential manner. For example, a state lottery can view national high level statistical information and can also drill down into detailed sales information within their own, and optionally only within their own, jurisdiction. Each set of analysis can be built to contain the detailed data for only that one lottery jurisdiction and no other. Each set can also be self-contained in that it does not require any connection back to the data source so there is no possibility to somehow accidentally or purposefully view the details of another lottery jurisdiction. The delivery of the set of analysis to the lottery jurisdiction can be done via secure method conforming to all security processes and protocols, in accordance with various embodiments of the present invention.

In various embodiments, the analytical output can to be linked to player data to understand, for example, where the players play, what games they play, whether they play in store or online, etc. In this way, the present invention assists in increasing player loyalty and player advocates for the attraction of additional players. In various embodiments, the present invention can employ statistical computing and graphics software programming in order to perform data analytics. Such programming can be developed using various software such as R, also called GNU S, for example. Models can be built and/or programmed in accordance with the present invention and run directly against multi-jurisdictional data, for example, where output of the predictive models can be viewed by the same visualization tool described in accordance herein.

Advantageously, retail chain profiles can be identified using aspects of the present invention to identify and exploit expansion opportunities. For example, insights gained using features of the present invention may be used to provide information to target new retailers and chain executives, such as, strategic, marketing, and operating information; past and current lottery activity in a given area; retailers co-located with lottery agents; competitor indices, and others.

It will be appreciated that at least one method employing a lottery communications system in accordance with the present invention comprises the steps of (1) receiving, over a first network, lottery transaction data associated with a plurality of lottery transactions occurring at one or more of a plurality of non-player operated retailer terminals in a first lottery jurisdiction and a plurality of player-operated retailer terminals in the first lottery jurisdiction; (2) receiving, over a second network, lottery transaction data associated with a plurality of lottery transactions occurring at one or more of a plurality of non-player operated retailer terminals in a second lottery jurisdiction and a plurality of player operated retailer terminals in the second lottery jurisdiction; (3) receiving, over a third network, non-lottery data associated with the first and second lottery jurisdictions; and (4) normalizing, using a central processing component, the lottery transaction data from the first and second lottery jurisdictions and the non-lottery data. The normalization of the data can include normalizing key retailer attributes and business data, for example, to inform relevant business decision making and performance optimization for various industry participants. The resultant data can align with lottery industry best practice information and/or form a standard set of data employable by lottery industry participants seeking to utilize lottery industry best practice information.

Further to the above, embodiments of the present invention include the normalizing step facilitating a cross-jurisdictional comparison of retailer characteristics, such as through intelligent mapping of the received data. It will be appreciated that the step of receiving data over the third network can include receiving automated feeds of data from at least one news source (e.g., an industry research service), wherein the received news can be words, letters, numbers, images, photographs, videos or any type of information in any format that is communicable over the network. It will further be appreciated that the above described method can include the further step of storing existing and potential lottery retailer data in a database, wherein the stored data is attributed based on at least one of strategic, performance and profile characteristics. For example, such characteristics may include strategic acquisition targets, new market expansion plans and new marketing promotions. It will also be appreciated that the above described normalizing step can include organizing the stored data based on comparisons of at least two retailers based on at least one of the retailers' market positioning, the retailers' growth strategy, the retailers' market segment, the retailers' distribution channels, the retailers' operating requirements, the retailers' customer profile and the retailers' social advocacies, for example.

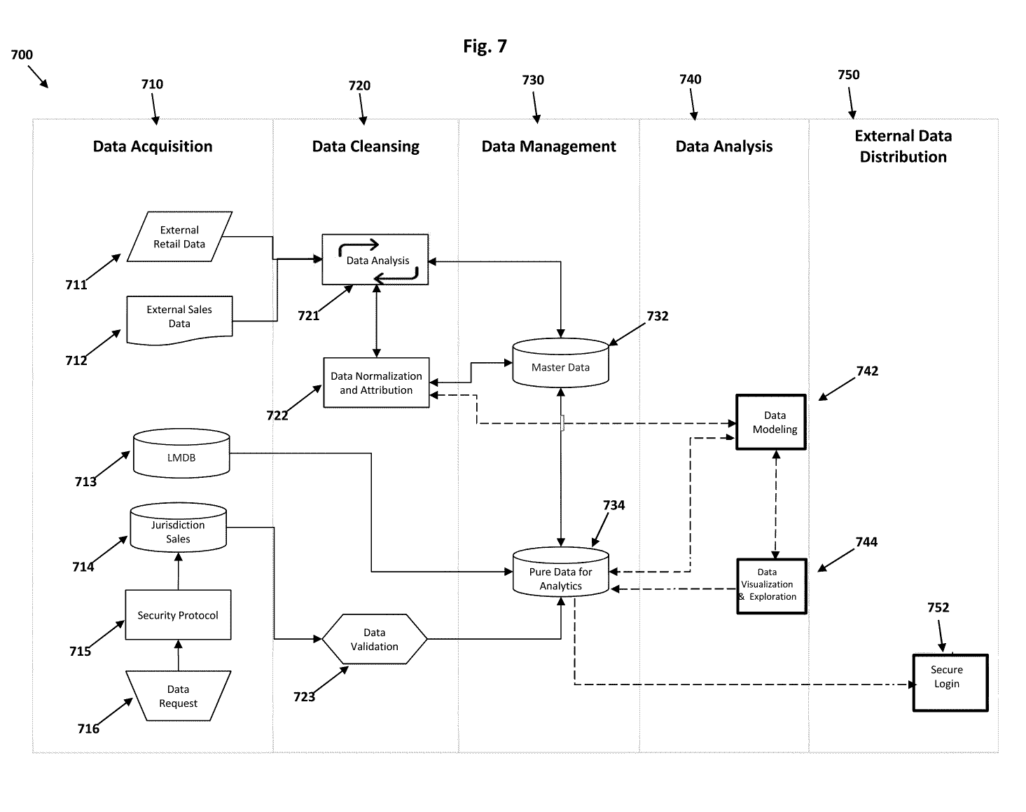

FIG. 7 illustrates an alternative schematic view to the illustration of FIG. 1. As shown and/or implied by FIG. 7, data may be acquired by system 700 at a data acquisition step 710. In some embodiments, data acquired for use in connection with aspects of the present invention at data acquisition step 710 can include lottery transaction data 711 from external sources such as retailers, as well as “internal” lottery data 712 as described above in connection with FIG. 1. This information can include information from multi-state lottery entities (e.g., MUSL), game sale data from lottery system providers (e.g., IGT and others), sales forecasts and budgets, information from business research services (e.g., Nielsen™, Hoovers™), convenience store and supermarket store directories, census information and retail information, for example. Generally, information of any type and format can be received. Further, the data can be collected according to automated systems configured to index and otherwise organize the acquired data, and/or the data can be entered manually into one or more computer-based systems operating programming according to the present invention. In one embodiment, the data is collected in .xlsx format (though other data collection formats may also be used (e.g., .xml, .csv, etc.)).

As further shown in FIG. 7, this data can be analyzed as at 721 and normalized as at 722, all as part of data cleansing step 720, and the analyzed and normalized data can be stored in a master database 732 as part of data management step 730. Additional “pure” data, such as data from a landscape management database (LMDB 713) can be stored in database 734 as part of data management step 732. Such data can include lottery game data, including lottery game results such as jackpots, winners and game attributes, for example, and this data can be used for analytical purposes as described elsewhere herein.

As part of data acquisition step 710, FIG. 7 also illustrates that a data request can be made as at 716 through a security protocol 715 for jurisdiction sales from a jurisdiction sales database 714. This sales data may provide additional data stored in database 734 (e.g., sales by day by game, sales by retailer by day by game, etc.) and can be validated during the data cleansing step 720 such as through a data validation process 723. Other data stored in database 734 can include, for example, retailer game level data, third party data (e.g., from external news sources), player data, retailer sales data and retailer characteristics data, for example.

Similar processes as described in connection with FIG. 1 can be performed in the data acquisition 710, cleansing 720 and management steps 730 of FIG. 7 via a central processing component as described elsewhere herein. For inputting/collecting the data associated with the lottery transactions across one or more jurisdictions, various hardware may be used, including non-player operated retailer terminals such as sales terminals, kiosks, or the like, and/or player operated retailer terminals such as user kiosks, user mobile devices/tablets, laptops, desktop computers, or any other device capable of identifying and collecting the necessary information and/or facilitating entry of the information by a user. Such hardware may, in some embodiments, be connected to a network (either via a hardwired connection or wireless connection) to facilitate the transfer of the collected information from individual collection points to remote storage locations (as discussed in more detail below). In preferred embodiments, a wide array of collection terminals may be employed to maximize the amount of data acquired and available for analysis.

At data analysis step 740 in FIG. 7, the lottery management system and/or processing component 250 may provide algorithms and other data manipulation programming to facilitate the various functions and purposes of the present invention. In some embodiments, the system may produce one or more user-specific outcomes, including outcomes as described above in connection with FIG. 1, data modeling outputs via a data modeling component of the processing component, and/or data visualization and exploration outputs via a data visualization component of the processing component, for example. As with FIG. 1, results and analysis may optionally be distributed externally (e.g., at external data distribution step 750) using secure logins (such as illustrated at 752) over various network interfaces known in the art.

It will be appreciated that all of the disclosed methods, analytics, and procedures described herein can be implemented using one or more computer programs or components, such as component 250. These components may be provided as a series of computer instructions on any conventional computer-readable medium, including RAM, ROM, flash memory, magnetic or optical disks, optical memory, or other storage media. The instructions may be configured to be executed by one or more processors which, when executing the series of computer instructions, performs or facilitates the performance of all or part of the disclosed methods, analytics, and procedures.

Unless otherwise stated, devices or components of the present invention that are in communication with each other do not need to be in continuous communication with each other. Further, devices or components in communication with other devices or components can communicate directly or indirectly through one or more intermediate devices, components or other intermediaries. Further, descriptions of embodiments of the present invention herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed general purpose computers and computing devices, for example. In this regard, a processor (e.g., a microprocessor or controller device) receives instructions from a memory or like storage device that contains and/or stores the instructions, and the processor executes those instructions, thereby performing a process defined by those instructions. Further, programs that implement such methods and algorithms can be stored and transmitted using a variety of known media. At a minimum, the memory includes at least one set of instructions that is either permanently or temporarily stored. The processor executes the instructions that are stored in order to process data. The set of instructions can include various instructions that perform a particular task or tasks. Such a set of instructions for performing a particular task can be characterized as a program, software program, software, engine, module, component, mechanism, or tool. Common forms of computer-readable media that may be used in the performance of the present invention include, but are not limited to, floppy disks, flexible disks, hard disks, magnetic tape, any other magnetic medium, CD-ROMs, DVDs, any other optical medium, punch cards, paper tape, any other physical medium with patterns of holes, RAM, PROM, EPROM, FLASH-EEPROM, any other memory chip or cartridge, or any other medium from which a computer can read. The term “computer-readable medium” when used in the present disclosure can refer to any medium that participates in providing data (e.g., instructions) that may be read by a computer, a processor or a like device. Such a medium can exist in many forms, including, for example, non-volatile media, volatile media, and transmission media. Non-volatile media include, for example, optical or magnetic disks and other persistent memory. Volatile media can include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications.

Various forms of computer readable media may be involved in carrying sequences of instructions associated with the present invention to a processor. For example, sequences of instruction can be delivered from RAM to a processor, carried over a wireless transmission medium, and/or formatted according to numerous formats, standards or protocols, such as Transmission Control Protocol/Internet Protocol (TCP/IP), Wi-Fi, Bluetooth, GSM, CDMA, EDGE and EVDO. Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art. Appropriate encryption and other security methodologies can also be employed by the system of the present invention, as will be understood to one of ordinary skill in the art.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

1. A method employing a lottery communications system, comprising the steps of:
receiving, over a first network, lottery transaction data associated with a plurality of lottery transactions occurring at one or more of a plurality of non-player operated retailer terminals in a first lottery jurisdiction and a plurality of player-operated retailer terminals in the first lottery jurisdiction;
receiving, over a second network, lottery transaction data associated with a plurality of lottery transactions occurring at one or more of a plurality of non-player operated retailer terminals in a second lottery jurisdiction and a plurality of player operated retailer terminals in the second lottery jurisdiction;
receiving, over a third network, non-lottery data associated with the first and second lottery jurisdictions; and
determining, using a central processing component and based on the lottery transaction data from the first and second lottery jurisdictions and the non-lottery data, a plurality of user-specific outcomes.

2. The method of claim 1, wherein the user-specific outcomes comprise one or more of a government lottery outcome, a lottery operator outcome, and a retailer outcome.

3. The method of claim 1, wherein the user-specific outcomes are communicated to users over a fourth network.

4. The method of claim 1, wherein the user-specific outcomes comprise one or more of sales per retailer, sales per retailer type, sales per store based on store size, sales per capita according to jurisdiction.

5. The method of claim 1, wherein the first, second, third, and fourth networks are the same network.

6. The method of claim 1 further comprising the steps of receiving lottery transaction data from one or more additional lottery jurisdictions via one or more additional networks.

7. The method of claim 1 wherein one or more of the first and second networks comprise local area networks connected to the internet.

8. A lottery communications system, comprising:
one or more computer processors adapted to execute a program stored in a computer memory, the program being operable to provide instructions to the one or more computer processors including:
receiving, over a first network, lottery transaction data associated with a plurality of lottery transactions occurring at one or more of a plurality of non-player operated retailer terminals in a first lottery jurisdiction and a plurality of player-operated retailer terminals in the first lottery jurisdiction;
receiving, over a second network, lottery transaction data associated with a plurality of lottery transactions occurring at one or more of a plurality of non-player operated retailer terminals in a second lottery jurisdiction and a plurality of player operated retailer terminals in the second lottery jurisdiction;
receiving, over a third network, non-lottery data associated with the first and second lottery jurisdictions; and
determining, using a central processing component and based on the lottery transaction data from the first and second lottery jurisdictions and the non-lottery data, a plurality of user-specific outcomes.

9. The system of claim 1, wherein the user-specific outcomes comprise one or more of a government lottery outcome, a lottery operator outcome, and a retailer outcome.

10. The system of claim 1, wherein the user-specific outcomes are communicated to users over a fourth network.

11. The system of claim 1, wherein the user-specific outcomes comprise one or more of sales per retailer, sales per retailer type, sales per store based on store size, sales per capita according to jurisdiction.

12. The system of claim 1, wherein the first, second, third, and fourth networks are the same network.

13. The system of claim 1 further comprising the steps of receiving lottery transaction data from one or more additional lottery jurisdictions via one or more additional networks.

14. The system of claim 1 wherein one or more of the first and second networks comprise local area networks connected to the internet.

15. A method employing a lottery communications system, comprising the steps of:
receiving, over a first network, lottery transaction data associated with a plurality of lottery transactions occurring at one or more of a plurality of non-player operated retailer terminals in a first lottery jurisdiction and a plurality of player-operated retailer terminals in the first lottery jurisdiction;
receiving, over a second network, lottery transaction data associated with a plurality of lottery transactions occurring at one or more of a plurality of non-player operated retailer terminals in a second lottery jurisdiction and a plurality of player operated retailer terminals in the second lottery jurisdiction;
receiving, over a third network, non-lottery data associated with the first and second lottery jurisdictions; and
normalizing, using a central processing component, the lottery transaction data from the first and second lottery jurisdictions and the non-lottery data.

16. The method of claim 15, wherein the normalizing step facilitates a cross-jurisdictional comparison of retailer characteristics.

17. The method of claim 15 wherein the step of receiving data over the third network includes receiving automated feeds of data from at least one news source.

18. The method of claim 16 including the further step of storing existing and potential lottery retailer data in a database, wherein the stored data is attributed based on at least one of strategic, performance and profile characteristics.

19. The method of claim of claim 18 wherein the normalizing step includes organizing the stored data based on comparisons of at least two retailers based on at least one of the retailers': market positioning, growth strategy, market segment, distribution channels, operating requirements, customer profile and social advocacies.
